(19) United States
(12) Patent Application Publication
(10) Pub. No.: US 2002/0080274 A1
(43) Pub. Date: Jun. 27, 2002

(54) Photograph display system

(76) Inventor: Franklin L. Gubernick, Tucson, AZ (US)

Correspondence Address: GUBERNICK ASSOCIATES, FRANKLIN L GUBERNICK, 2540 N RISING STAR TR, TUCSON, AZ, 85745

(21) Appl. No.: 10/025,949

(22) Filed: Dec. 19, 2001

Related U.S. Application Data
(60) Provisional application No. 60/258,135, filed on Dec. 21, 2000.

(51) Int. Cl. H04N 11/00; H04N 7/00

(52) U.S. Cl. 348/552; 348/553

(57) ABSTRACT

Disclosed is a television that includes a memory storage device into which is stored one or more still photographs in digital form. The invention enables a television to include a feature that allows a user to change the television display to show a still photograph for an extended period of time in lieu of a television program or movie. In one version of the invention, the television includes a connector that allows a still photograph to be downloaded into a memory chip installed within the television. In a second version of the invention, the television includes a receiver for a removable memory device, such as a floppy disk or a flash memory chip. The removable memory device includes a still photograph, in digital form, that can then be accessed by the television and displayed on the television's screen.

This application claims the benefit of U.S. Provisional application No. 60/258,135 filed Dec. 21, 2000.

### FIELD OF THE INVENTION

The invention is primarily in the field of television equipment. More particularly, the invention is a television that includes a memory device, powered by the television, into which a user may download and store one or more of the user's favorite still photographs in digital form. The invention then enables the user to change the television display from showing a television show or movie to instead display a stored still photograph. The photograph can be displayed for an extended period of time, or when multiple photographs have been stored, the user, or an automatic capability within the television, can cause the television to display the photographs in an alternating sequence.

### BACKGROUND OF THE INVENTION

A television is a standard appliance in most homes. For many people, they will own a number of televisions to enable them to view shows in different areas of the home. To provide the television with the ability to display television shows and movies, the television must be connected to an antennae, cable TV system, satellite TV system, videocassette recorder (VCR) or digital versatile/video disk (DVD) player. An advantage of a VCR or DVD is that it enables a person to more directly select the television show or movie that will be displayed by the television.

When a person is done watching one or more television shows and/or movies, he or she will typically turn the television off. At that point, the television becomes a basically non-functional piece of furniture. However, even after the television is turned off, the television will still consume some electricity due to the “instant-on” feature found on almost every commonly sold television. Therefore, during the time period when the television is non-functional, the owner is still paying for its operation.

Digital cameras are presently available that allow a user to take a photograph without the use of film. The still photograph is normally stored on a memory device within the camera until it can be downloaded into a computer. Once in the computer, the still photograph can be displayed on the computer's monitor, and then printed using a printer connected to the computer. At the present time, there is no method or capability for displaying a still photograph in digital form using other household devices.

### SUMMARY OF THE INVENTION

The invention is a television that includes a memory device into which is stored one or more still photographs in digital form. This enables the television to include a feature whereby a user can change the television display from showing a movie or television show to instead show a still photograph that is stored within the television's memory. In this manner, when the user is done watching a television show or movie, instead of turning the television “off,” the television can be used to display, for extended periods, one or more of a user's favorite photographs.

In a first primary embodiment of the invention, the television includes a memory chip installed within the television, preferably on its main circuit board. The memory chip is powered by the television and is preferably similar or identical to a random access memory (RAM) chip or flash memory chip used in most computers for temporarily storing information. These chips can be made to store as little as one megabyte of information to more than 32 megabytes of information.

The television in accordance with the first embodiment of the invention further includes a connector/port, similar or identical to a USB port found in most computers, whereby the television can be connected by a cable to a computer or digital camera. Alternatively, a conventional wireless connection can be used. This allows a photograph that is in digital form to be downloaded into the television's memory chip. Preferably, the memory size of the television's memory chip will be sufficiently large to enable a number of still photographs to be retained in memory. When multiple still photographs are stored, a user will then be able to choose which still photograph will be displayed, or for there to be an automatic cycling/changing of the displayed photographs.

In a second preferred embodiment of the invention, the television includes a receiver for a portable memory device. The receiver is powered by the television and can be in the form of a disk drive or a port for a memory chip. When the receiver is a disk drive, the user can insert into the receiver a floppy disk in which one or more still photographs have been stored in digital form. The television will then read the disk and display the photographs directly from the disk. When the receiver is in the form of a port, the user can then insert into the port a memory chip, such as the SONY MEMORY STICK, in which one or more still photographs have been stored in digital form. The port is wired to the television's circuit board whereby the information on the chip can be used directly by the television to enable a still photograph on the chip to be displayed on the television's screen. In a modification of this embodiment, the disk and/or removable memory chip can be read by the television and the information then stored in a memory chip, similar to that of the first embodiment, that is permanently or semi-permanently installed within the television.

### BRIEF DESCRIPTION OF THE DRAWINGS

FIG. 1 is a generalized schematic diagram of a television having a still photograph display system in accordance with a first embodiment of the invention.

FIG. 2 is a generalized schematic diagram of a television having a still photograph display system in accordance with a second embodiment of the invention.

FIG. 3 is a generalized schematic diagram of a television having a still photograph display system in accordance with a modified version of the second embodiment of the invention.

### DETAILED DESCRIPTION OF THE DRAWINGS

Referring now to the drawings in greater detail, wherein like reference numbers refer to like parts throughout the several figures, there is shown by the numeral 1 a television in accordance with a first embodiment of the invention.

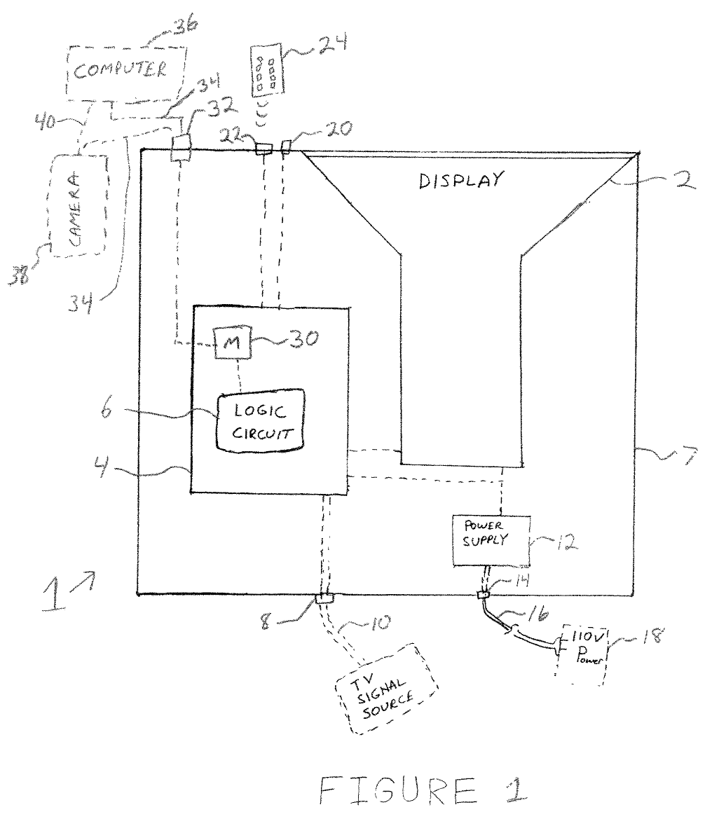

FIG. 1 is a generalized schematic diagram of the substantially conventional television 1. As included in most televisions, the television 1 includes a display 2. The display will typically be a cathode ray tube (CRT), but may also be an LCD display or other conventional display device. As also found in conventional televisions, the display 2 is connected to a predominantly conventional circuit board 4 that includes a logic circuit 6 for controlling the images shown by the display 2. The television's main components are secured to the television's outer housing 7.

Located at the rear of the television is a coaxial connector 8 that is wired to the circuit board. A removable coaxial wire 10, that is not part of the television, is attached to the connector and provides an input of a television feed signal comprising television shows and/or movies from a source such as a cable TV system, satellite TV system, VCR and/or DVD player. The television feed signal goes through wire 10, into the connector 8, and then into the circuit board via either a wire or hard connection. The signal is translated and interpreted by the logic circuit and then, in combination with other components of the circuit board, a control signal is sent to the display 2 to cause it to display the appropriate images of the television show/movie.

Like all televisions, a power supply 12 is used to provide power to all of the television's different components, including the display and circuit board. The power supply is located within the television and may either be a separate unit that is connected to the circuit board by wires or the like, or may be integral with the circuit board as a source point for electrical power. As shown, the power supply will be electrically connected by wire/connector 14 to an exterior wire 16 that is located at the rear of the television. Wire 16 is releasably connected to a source of electricity 18, such as one of the home's electrical outlets.

As also found on most conventional televisions, the front of the television includes a button-type switch 20 that is connected to the circuit board. A user can manually press switch 20 and cause the television to change channels in the conventional manner, i.e.—to display images resulting from data transmitted by different portions of the inputted feed signal. As also conventional, the front of the television includes a sensor 22 that is capable of detecting signals transmitted from a remote control unit 24. The sensor is electrically connected to the circuit board whereby a user can operate the remote control unit to change television channels from a location that is spaced from the television.

Unlike conventional televisions, the television 1 includes a memory chip 30 that is powered by the power supply 12. The chip is preferably mounted on the circuit board 4, but may alternatively be located elsewhere in, or on, the television and electrically connected to the circuit board. Electrically connected to the chip 30 is a photograph input port 32.

The photograph input port 32 is preferably located on the front of the television. The port is preferably conventional in design, such as a standard USB port. The port can be releasably connected to one end of a standard connector cable 34. The other end of the cable 34 can be releasably connected to a matching port of a computer 36 or possibly directly to a matching port of a digital camera 38. The cable enables a still photograph, in digital form, to be downloaded into the television's chip 30 from the computer or camera, i.e.—to travel from the computer/camera through the cable, into the television's port 32, and then into the memory chip 30. It should be noted that as an alternative that is not shown, the port 32 can instead be a wireless port, such as an Apple Computer, Inc. FIREWIRE port, and thereby enable a wireless connection between the computer and remote device.

In operation, a user will typically take a photograph with the digital camera 38. The user then downloads the photograph into the computer 36 through either a cable connection 40, or via a removable memory storage device (not shown) such as a floppy disk or a memory chip (an example of such a chip is the SONY MEMORY STICK). The user will then typically use the computer to work with the photograph, i.e.—make it lighter or darker, crop it, change its size, change the photograph's contrast, etc. Once the user is satisfied with the photograph, the user can then releasably connect the computer to the television's photograph input port 32 using the cable 34.

While a computer will typically be used to manipulate the still photograph taken by the camera, the still photograph can be directly downloaded from the camera to the television. This would be accomplished by connecting one end of cable 34 to the camera 38 and the other end of cable 34 to the television's photograph input port 32. This alternate arrangement is portrayed by the second cable 34 shown in FIG. 1.

Once the computer or camera is connected to port 32, the user then downloads one or more still photographs into the television's memory chip 30. Preferably, the circuit board includes a logic circuit that includes embedded software whereby the user could activate a pop-up menu on the television and choose an option to download a photograph. Additional software in the television's logic circuit would then cause the still picture information to be transferred from the computer's or camera's memory into the television's memory chip 30. In the preferred embodiment, the chip 30 is capable of storing multiple still photographs.

In the preferred embodiment, once the still photograph(s) have been downloaded into the memory chip 30, a user can then press the channel button 20, or an equivalent channel button on the remote control unit, to a predetermined channel/setting to cause a still photograph, from memory chip 30, to be displayed on the television. In the preferred embodiment, this would be accomplished using additional embedded software of the logic circuit, and possibly hardware that is also a portion of the logic circuit and located on the circuit board. When activated by the user, the software and/or hardware of the logic circuit would preferably discontinue processing the information feed from connector 8 and would instead go to the memory chip 30 for feed information that would be processed and then shown as a still photograph by display 2. For example, the television feed from the antennae, cable TV company, etc. via connector 8 may include channels 1-100. The television 1 may allow a user to select any one of channels 1-104, wherein the first 100 channels are inputted via connector 8, and channels 101-104 are displayed based on information from the memory chip 30. The user could then press the channel button for channel 102, whereby the logic circuit including said software and/or hardware would discontinue processing the information feed from connector 8, and instead use information from the memory chip to display a stored still photograph from chip 30 on the display 2. If the user had four still photographs recorded on the memory chip 30, the user could then select any of the four photographs by changing the television's channel selector to an associated one of the channels 101-104. It should be noted that in this manner, a still photograph can be displayed for an extended period of time, such as a few minutes or hours.

It should be noted that the above-described manual control for determining which still photograph will be displayed can be supplemented by an automatic control. Said automatic control would preferably be included in the television's logic circuit and be in the form of embedded software and/or hardware that functions to cycle/change the displayed image so that one still photograph is displayed for a period of time, and then the control causes another still photograph or some other image to be displayed for a period of time. The automatic control would then function as a screen saver to prevent any particular photograph from being displayed for too long a period of time.

As an alternative to using one or more of the television's channels for displaying the still photographs, the television and/or remote control unit may include a separate still photograph button labeled ‘P’ or the like. Said button would preferably have the sole function of causing the logic circuit to draw image information for the display 2 from the memory chip 30 in lieu of from the feed via connector 8.

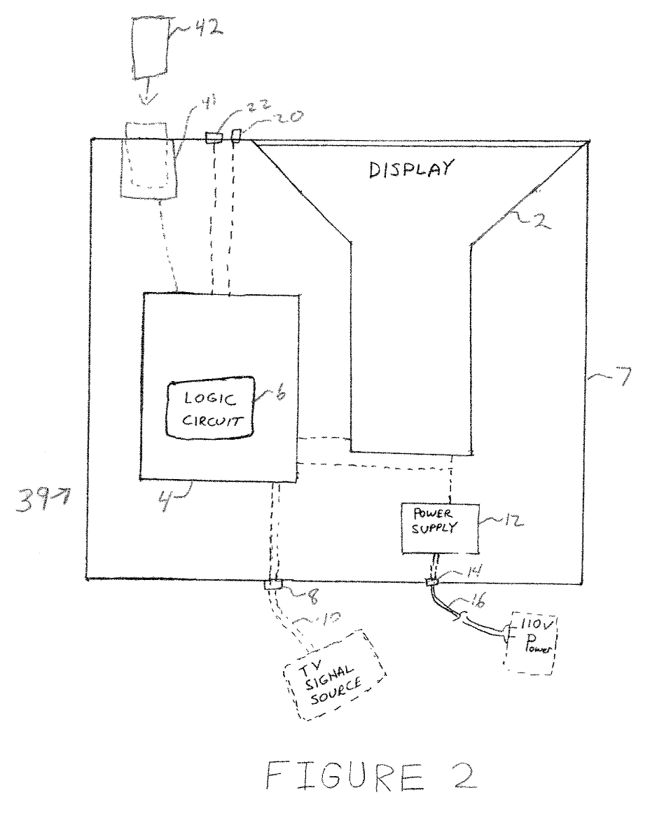

FIG. 2 shows a second embodiment of the invention. The figure shows a substantially conventional television 39 that is basically identical to the television 1. However, instead of the television having a permanently or semi-permanently installed memory chip 30, the television includes a receiver 41 designed to receive a removable memory device 42. Depending on the design of the receiver, the memory device 42 may be a floppy disk, or a memory chip such as a SONY MEMORY STICK. The receiver 41 is preferably located on the front of the television and is electrically connected to the circuit board whereby it is powered by the television's power supply 12.

The function of the removable memory device 42 is basically conventional. As is well known in the digital camera art, one can take a still photograph with a digital camera and the camera will then store the photograph in a removable memory device 42 located in a complementary receiver in the camera. The still photograph may also be downloaded into a computer and then stored in a removable memory device 42 located in a complementary receiver in the computer. Once the memory device 42 has at least one stored still photograph, it can then be removed from the computer or camera, and inserted into the television's receiver 41. When the memory device is a floppy disk, the receiver 41 will be in the form of a disk drive. When the removable memory device is in the form of a memory chip, the receiver will include the appropriate connections for reading from the chip.

When a user wishes to view one of the still photographs stored in the memory device 42, the memory device is inserted into the television's receiver 41. Once the memory device is in the receiver, the process for viewing the photograph is basically the same as described for the first embodiment of the invention. The user presses the appropriate button on the television or the remote control unit, and then the logic circuit discontinues the feed from input 8 and instead goes to the memory device 42 its input. The logic circuit then causes a picture to be shown on the display 2 based on the information stored in the memory device 42.

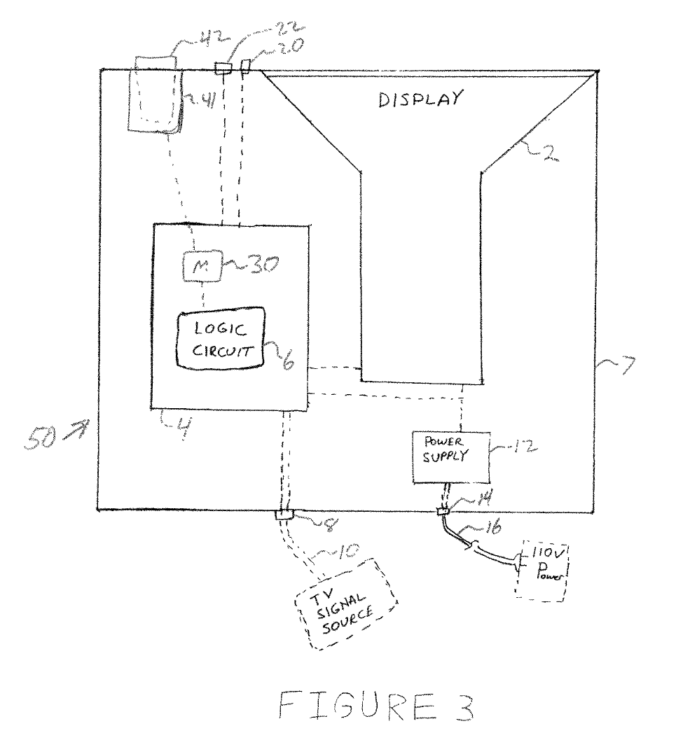

In FIG. 3, the television 50 is basically the same as television 39, except that the circuit board also includes a memory chip 30. Additionally, the television includes software to create a pop-up menu and/or the television or remote control unit includes a button-type switch that can be actuated by a user to cause the stored information in the removable memory device 42 to be downloaded via the receiver 41 and sent into the memory chip 30. Once the memory device 42 has been downloaded into the chip 30, a user can press switch 20 or an equivalent button in the remote control unit to cause the logic circuit to discontinue processing the television data feed from connection 8 and instead pull the still photograph information from the chip 30 and cause said still photograph to be shown by the television's display 2.

It should be noted that when the memory chip 30 is described as being permanently or semi-permanently installed within the television, what is meant by permanent is that the chip is not designed to be readily removable and is, for example, soldered in place. A semi-permanent installation of the memory chip is one where the chip will normally not be removed from the television, but is designed whereby it can be easily removed by a user, in the same manner as a RAM chip in a computer.

It should also be noted that a circuit board is herein broadly defined as a construct of multiple electrical circuits and components and may comprise multiple boards and components.

The preferred embodiments of the invention disclosed herein have been discussed for the purpose of familiarizing the reader with the novel aspects of the invention. Although preferred embodiments of the invention have been shown and described, many changes, modifications and substitutions may be made by one having ordinary skill in the art without necessarily departing from the spirit and scope of the invention as described in the following claims.

I claim:

1. A multi-purpose television primarily designed to display television shows and movies, said television comprising:
a housing;
a display unit secured to said housing and located whereby said display unit is capable of displaying a picture that is visible to a person located exterior to said housing;
a circuit board located within said housing and operatively connected to said display unit;
a television signal input connector that is accessible from exterior of the television, is operatively connected to said circuit board and is capable of being releasably operatively connected to a source of television signals;
a still photograph data input connector that is accessible from exterior to the television, is operatively connected to said circuit board and is capable of receiving input from a source of at least one still photograph in digital form;
a memory chip at least partially located within said housing and operatively connected to said circuit board and to said still photograph data input connector;
a power supply located within said housing and capable of being connected to a source of electricity located exterior to said television, wherein said power supply provides electrical power for said display unit, said circuit board and said memory chip; and
a logic circuit that is operatively connected to said circuit board, wherein said logic circuit can be activated by a user to cause information stored within said memory chip to be processed and displayed as a still photograph by said display unit in lieu of an image derived from information received via said television signal input connector.

2. The television of claim 1 further comprising a remote control unit capable of sending a signal to a sensor that is operatively connected to said circuit board, wherein said remote control unit includes a switch actuable by a user to cause information stored within said memory chip to be processed and displayed as a still photograph by said display unit in lieu of an image derived from information received via said television signal input connector.

3. The television of claim 2 wherein said remote control unit also includes a second switch associated with determining which channel of the information received by the television signal input connector will be displayed by the display unit.

4. The television of claim 1 wherein the memory chip is permanently secured within the television's housing.

5. The television of claim 1 wherein the memory chip is semi-permanently secured within said housing.

6. The television of claim 1 wherein the memory chip is removable from said television.

7. The television of claim 1 wherein the still photograph data input connector includes an opening into which a memory storage device may be removably inserted and downloaded to the circuit board.

8. The television of claim 1 wherein the still photograph data input connector is designed to be releasably operatively connected to a first end of an electrical cable and wherein a second end of said cable is designed to be connected to a port of a computer.

9. The television of claim 1 wherein the still photograph data input connector is designed to be releasably operatively connected to a first end of an electrical cable and wherein a second end of said cable is designed to be connected to a port of a digital camera.

10. The television of claim 1 wherein said logic circuit includes a software portion and a hardware portion.

11. The television of claim 1 wherein when said still photograph data input connector receives input from a source of at least one still photograph in digital form, said logic circuit includes software that is actuable by a user to cause said still photograph information to be downloaded to said memory chip.

12. A multi-purpose television primarily designed to display television shows and movies, said television comprising:
a housing;
a display unit secured to said housing and located whereby said display unit is capable of displaying a picture that is visible to a person located exterior to said housing;
a circuit board located within said housing and operatively connected to said display unit;
a television signal input connector that is accessible from exterior of the television, is operatively connected to said circuit board and is capable of being releasably operatively connected to a source of television signals;
a still photograph data input receiver that is accessible from exterior to the television, is operatively connected to said circuit board and is capable of removably receiving a memory storage device in which at least one still photograph is stored in digital form;
a power supply located within said housing and capable of being connected to a source of electricity located exterior to said television, wherein said power supply provides electrical power for said display unit, said circuit board, and said still photograph data input receiver; and
a logic circuit located within said housing and operatively connected to said circuit board, wherein when said memory storage device is located in said receiver, said logic circuit can be activated by a user to cause information stored within said memory storage device to be processed in a manner whereby said still photograph of said memory storage device will be displayed by said display unit in lieu of an image derived from information received via said television signal input connector.

13. The television of claim 12 wherein said receiver is in the form of a disk drive powered by said power supply.

14. A multi-purpose television primarily designed to display television shows and movies, said television comprising:
a housing;
a display unit secured to said housing and located whereby said display unit is capable of displaying a picture that is visible to a person located exterior to said housing;
a circuit board located within said housing and operatively connected to said display unit;
a television signal input connector that is accessible from exterior of the television, is operatively connected to said circuit board and is capable of being releasably operatively connected to a source of television signals;
a still photograph data input receiver that is accessible from exterior to the television, is operatively connected to said circuit board and is capable of removably receiving a memory storage device in which at least one still photograph is stored in digital form;
a memory chip located within said housing and operatively connected to said circuit board and to said still photograph data input receiver;
a power supply located within said housing and capable of being connected to a source of electricity located exterior to said television, wherein said power supply provides electrical power for said display unit, said circuit board, said still photograph data input receiver, and said memory chip; and
a logic circuit located within said housing and operatively connected to said circuit board, wherein when a memory storage device is located within said receiver, said logic circuit can be actuated by a user to cause still photograph information located in said memory storage device to be transferred into said memory chip, and wherein said logic circuit can also be activated by a user to cause information stored within said memory chip to be processed and displayed as a still photograph by said display unit in lieu of an image derived from information received via said television signal input connector.
